(19) United States
(12) Patent Application Publication
(10) Pub. No.: US 2023/0128948 A1
(43) Pub. Date: Apr. 27, 2023

(54) VALVE APPLICATION SYSTEM AND METHOD

(71) Applicant: Illinois Tool Works Inc., Glenview, IL (US)

(72) Inventor: Christopher Ludwig, Buffalo Grove, IL (US)

(73) Assignee: Illinois Tool Works Inc., Glenview, IL (US)

(21) Appl. No.: 17/962,865

(22) Filed: Oct. 10, 2022

Related U.S. Application Data
(60) Provisional application No. 63/272,224, filed on Oct. 27, 2021.

(51) Int. Cl. B65B 51/22; B65B 51/26; B65B 9/20

(52) U.S. Cl. CPC B65B 51/225; B65B 51/26; B65B 9/20

(57) ABSTRACT

A valve application system includes a rotary cutter configured to cut individual valves from a valve string. The valve string is configured to be fed between the rotary cutter and a vacuum transfer tool where the rotary cutter is configured to cut the individual valves from the valve string. The valves are configured to be transferred from the vacuum transfer tool to the ultrasonic anvil. A web is configured to be fed between the ultrasonic anvil and the ultrasonic horn where the valves are ultrasonically sealed to the web.

### CROSS-REFERENCE TO RELATED APPLICATIONS

This application claims priority to U.S. Provisional Application No. 63/272,224 (filed 27 Oct. 2021), the entire disclosure of which is incorporated herein by reference.

### BACKGROUND

### Technical Field

The subject matter described herein relates to systems and methods for forming a package (such as a pouch, bag, or the like), and more particularly to systems and methods for coupling valves to webs of material.

### Discussion of Art

Certain products are retained in packages, such as pouches. The pouches are formed of flexible polymers, such as polyolefin-based packaging films. The pouches can be used to retain and contain liquids, for example.

Certain packages include a valve that is configured to be selectively opened and closed. In the closed position, the valve prevents fluids within the package from passing out of the package. In the open position, the valve allows the fluid to be poured or otherwise dispensed from the package. In short, valves have been developed to contain liquids within flexible packaging with the intent of using a flexible to semi-rigid, controllable method of containment.

Traditional packaging in the food/beverage, personal care and household care industries is primarily a combination of a rigid bottle or semi-flexible tube with a rigid fitment (cap) of varying dispense types. Transition to flexible pouches for the main body of the container has continued to utilize similar, still rigid, fitments.

There exists a need within these industries to complete the transition in order to create a fully flexible solution. Such provides both a flow control mechanism and re-closeable feature, enhances the overall sustainability profile and cost reduction of the packaging through material reduction and operational efficiency gains, and improves performance expectations in the growing e-commerce market.

A typical valve applicator utilizes intermittent motion to pull a string of valves, arranged in head-to-toe configuration, separates the valve into a single unit via a guillotine style blade, and applies the valve to a vacuum drum and seal to the film utilizing a traditional heat seal platen. However, the typical valve applicator is limited in terms of speed by a heat-sealing dwell time to an application speed of no greater than sixty valves per minute.

### BRIEF DESCRIPTION

A need exists for a system and a method for efficiently and effectively applying (such as securing or otherwise coupling) valves to a web of material to form packages, such as pouches.

With that need in mind, certain embodiments of the present disclosure provide a valve application system including a rotary cutter configured to cut individual valves from a valve string. The valve string is configured to be fed between the rotary cutter and a vacuum transfer tool where the rotary cutter is configured to cut the individual valves from the valve string. The valves are configured to be transferred from the vacuum transfer tool to the ultrasonic anvil. A web is configured to be fed between the ultrasonic anvil and the ultrasonic horn where the valves are ultrasonically sealed to the web.

In at least one embodiment, the valves in the valve strings are arranged in a side-by-side configuration.

In at least one example, the rotary cutter, the vacuum transfer tool, the ultrasonic anvil, and the ultrasonic horn are at a common location. As a further example, the rotary cutter, the vacuum transfer tool, the ultrasonic anvil, and the ultrasonic horn form a common assembly.

In at least one embodiment, the rotary cutter includes a first drum, the vacuum transfer tool comprises a second drum, the ultrasonic anvil comprises a third drum, and the ultrasonic horn comprises a fourth drum. As a further example, the first drum, the second drum, the third drum, and the fourth drum are configured to rotate. As a further example, the first drum rotates in a first direction, the second drum rotates in a second direction in opposition to the first direction, the third drum rotates in a third direction in opposition to the second direction, and the fourth drum rotates in a fourth direction in opposition to the third direction. In at least one example, the first direction and the third direction are counterclockwise, and the second direction and the fourth direction are clockwise.

In at least one embodiment, the rotary cutter, the vacuum transfer tool, the ultrasonic anvil, and the ultrasonic horn are configured to continually rotate during operation.

Certain embodiments of the present disclosure provide a valve application method, comprising feeding a valve string between a rotary cutter and a vacuum transfer tool; cutting, by the rotary cutter, individual valves from the valve string; transferring the valves from the vacuum transfer tool to an ultrasonic anvil; feeding a web between the ultrasonic anvil and an ultrasonic horn; and ultrasonically sealing the valves to the web between the ultrasonic horn and the ultrasonic anvil.

### BRIEF DESCRIPTION OF THE DRAWINGS

The inventive subject matter may be understood from reading the following description of non-limiting embodiments, with reference to the attached drawings, wherein below:

FIG. 1 illustrates a schematic block diagram of a valve application system, according to an embodiment of the present disclosure;

FIG. 2 illustrates a simplified lateral view of a valve string, according to an embodiment of the present disclosure;

FIG. 3 illustrates a simplified lateral view of the valve application system, according to an embodiment of the present disclosure; and

FIG. 4 illustrates a flow chart of a valve application method, according to an embodiment of the present disclosure.

### DETAILED DESCRIPTION

Certain embodiments of the present disclosure provide a valve application system and method that exhibit a significantly higher application rate, as compared to the typical valve applicator, through use of rotary motion and ultrasonic sealing. Embodiments of the present disclosure provide systems and methods associated with the application of flexible valves to a piece of film (web) to be used in relation to a finished flexible pouch.

In at least one embodiment, the valve application system includes a series of four rotary drums. Valves are manufactured in a side-by-side configuration, in contrast to a head-to-toe configuration. A valve string flows in a parallel plane and same direction as a web flow. The valve string passes between a rotary cutting blade and a vacuum drum that provides a cutting anvil. This vacuum drum transfers valves cut from the valve string and deposits the valves on a second vacuum drum contained in an ultrasonic sealing anvil pattern. That second vacuum drum rotates the individual valves into position and mates a rotary (lobed) ultrasonic horn to seal the valve into position on the web that is moving continuously, such as at rates up to 300 pouches per minute.

As described herein, a package, such as a pouch, is formed from a web of material. A valve is sealingly secured to the web. The web can then be rolled, folded, and/or the like to form a liquid tight retaining package having the valve that is configured to be selectively opened and closed. The package can be formed from one or more webs, such as one or more films, formed of a material. The web(s) can be formed of polyethylene, PET, LDPE, and/or the like. The web(s) can be formed of plural layers coupled together, such as via lamination, heat sealing, extrusion, cold sealing (sealing with an adhesive and application of pressure but without heating), and/or the like. In at least one embodiment, the web(s) is provided as a flexible sheet, which can be rolled, folded, and/or the like to form a liquid tight retaining package.

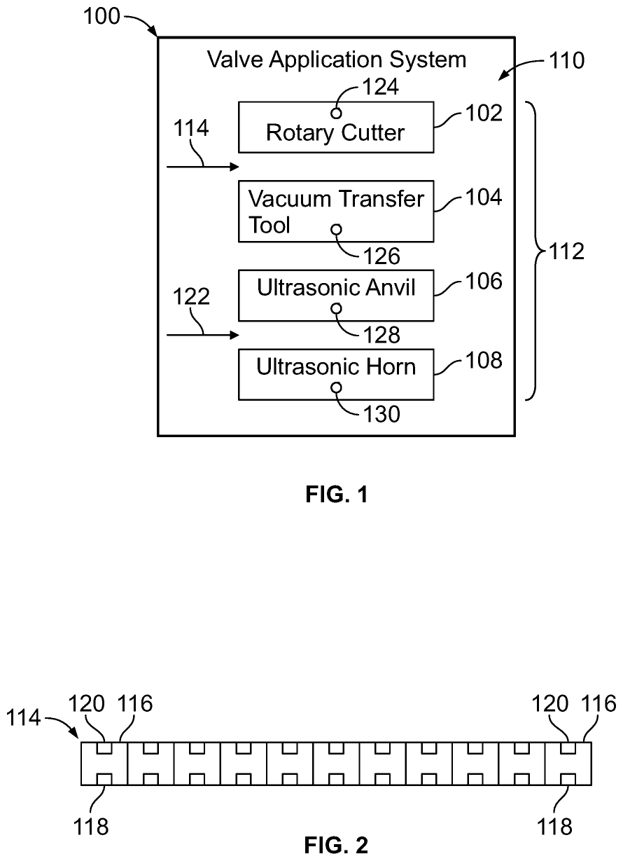

FIG. 1 illustrates a schematic block diagram of a valve application system 100, according to an embodiment of the present disclosure. The valve application system 100 may include a rotary cutter 102, a vacuum transfer tool 104, an ultrasonic anvil 106, and an ultrasonic horn 108. The rotary cutter 102, the vacuum transfer tool 104, the ultrasonic anvil 106, and the ultrasonic horn 108 may be at a common location 110. In at least one embodiment, the rotary cutter 102, the vacuum transfer tool 104, the ultrasonic anvil 106, and the ultrasonic horn 108 can form (for example, are part of) a common assembly 112. As an example, the rotary cutter 102, the vacuum transfer tool 104, the ultrasonic anvil 106, and the ultrasonic horn 108 can be contained within a common housing. Optionally, one or more of the rotary cutter 102, the vacuum transfer tool 104, the ultrasonic anvil, and the ultrasonic horn 108 may be outside of a housing.

In operation, a valve string 114 can be fed between the rotary cutter 102 and the vacuum transfer tool 104. The valve string 114 may be a continuous string of individual valves connected in a side-by-side configuration.

FIG. 2 illustrates a simplified lateral view of the valve string 114, according to an embodiment of the present disclosure. In at least one embodiment, the valve string 114 may include plural individual valves 116 connected together in a side-by-side configuration. Each valve 116 may include an inlet 118 and an outlet 120. When a valve 116 is sealingly secured to a package, the inlet 118 may receive a fluid (such as liquid) from a main body of the package. When the valve 116 is in the open position, the fluid can be dispensed from the outlet 120.

Referring to FIGS. 1 and 2, the valve string 114 can be fed between the rotary cutter 102 and the vacuum transfer tool 104. The rotary cutter 102 may cut the individual valves 116 from the valve string 114. In at least one example, the blades of the rotary cutter 102 may separate the individual valves 116, which are directly transferred to the vacuum transfer tool 104. As another example, as the individual valves 116 are separated from the valve string 114, the valves 116 can be spaced a predetermined distance on the rotary cutter 102, and rotated onto the vacuum transfer tool 104.

The vacuum transfer tool 104 may exert a vacuum force that transfers the individual valves 116 onto an outer surface of the vacuum transfer tool 104. The vacuum transfer tool 104 may maintain the valves 116 on the outer surface, through the vacuum force, as the vacuum transfer tool 104 rotates in opposition to the rotary cutter 102 (e.g., rotates in an opposite direction). The vacuum transfer tool 104 may rotate the valves 116 onto the ultrasonic anvil 106, which can rotate in opposition to the vacuum transfer tool 104. In at least one embodiment, the ultrasonic anvil 106 also may apply a vacuum force, which can transfer the valves 116 onto an outer surface of the ultrasonic anvil 106 at a predetermined spacing.

The ultrasonic anvil 106 may continue to rotate and bring the valves 116 into a location between the ultrasonic anvil 106 and the ultrasonic horn 108, which may rotate in opposition to the ultrasonic anvil 106. A web 122 can be fed between the ultrasonic anvil 106 and the ultrasonic horn 108. The ultrasonic horn 108 may exert ultrasonic energy into the web 122 while the valves 116 are located between the ultrasonic horn 108 and the ultrasonic anvil 106, thereby ultrasonically sealing the valves 116 to the web 122 at predetermined locations where the ultrasonic energy is applied.

In at least one embodiment, the rotary cutter 102 may include or is otherwise coupled to an actuator 124, such as a rotary motor, that causes the rotary cutter 102 to rotate. Similarly, the vacuum transfer tool 104 may include or may otherwise be coupled to an actuator 126, such as a rotary motor, that causes the vacuum transfer tool 104 to rotate. Similarly, the ultrasonic anvil 106 may include or be otherwise coupled to an actuator 128, such as a rotary motor, that causes the ultrasonic anvil 106 to rotate. Similarly, the ultrasonic horn 108 may include or be otherwise coupled to an actuator 130, such as a rotary motor, that causes the ultrasonic horn 108 to rotate.

Optionally, less than all the rotary cutter 102, the vacuum transfer tool 104, the ultrasonic anvil 106, and the ultrasonic horn 108 may include or be otherwise coupled to an actuator. For example, a single actuator, such as that of the rotary cutter 102, can be used to cause the rotary cutter 102 to rotate. Because the rotary cutter 102, the vacuum transfer tool 104, the ultrasonic anvil 106, and the ultrasonic horn 108 may have surfaces that contact one another, rotation of the rotary cutter 102 may cause corresponding rotation in each of the vacuum transfer tool 104, the ultrasonic anvil 106, and the ultrasonic horn 108. The rotational feeding of the materials in this way can allow for a faster rate of production of the valves 116 and applying the valves 116 to the webs.

The valve string 114 can be fed between the rotary cutter 102 and the vacuum transfer tool 104 by a separate feed actuator, such as a linear feed motor. Similarly, the web 122 can be fed between the ultrasonic anvil 106 and the ultrasonic horn 108 by a separate feed actuator, such as a linear feed motor. Optionally, the valve string 114 and the web 122 can be fed (for example, drawn in) by rotation of the rotary cutter 102, the vacuum transfer tool 104, the ultrasonic anvil 106, and/or the ultrasonic horn 108.

As described herein, the valve application system 100 includes the rotary cutter 102 configured to cut individual valves 116 from the valve string 114. The valve string 114 is configured to be fed between the rotary cutter 102 and the vacuum transfer tool 104 where the rotary cutter 102 is configured to cut the individual valves 116 from the valve string 114. The valves 116 are configured to be transferred from the vacuum transfer tool 104 to the ultrasonic anvil 106 (such as via rotation of the vacuum transfer tool 104 and the ultrasonic anvil 106). The web 122 is configured to be fed between the ultrasonic anvil 106 and the ultrasonic horn 108 where the valves 116 are ultrasonically sealed to the web 122.

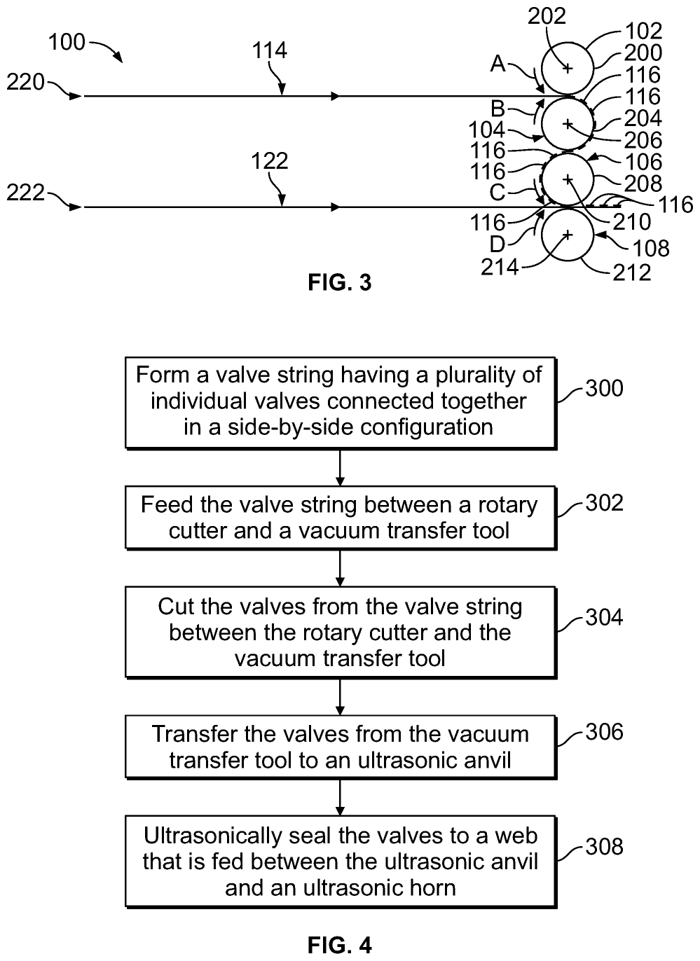

FIG. 3 illustrates a simplified lateral view of the valve application system 100, according to an embodiment of the present disclosure. The rotary cutter 102 can include a drum or cylinder 200 that is configured to rotate about a first axis 202 in the direction of arc A, such as a counterclockwise direction. The vacuum transfer tool 104 can include a drum or cylinder 204 that is configured to rotate about a second axis 206 in the direction of arc B, which is in opposition to the direction of arc A, such as in a clockwise direction. The ultrasonic anvil 106 can include a drum or cylinder 208 that is configured to rotate about a third axis 210 in the direction of arc C, which is in opposition to the direction of arc B, such as in a counterclockwise direction. The ultrasonic horn 108 can include a drum or cylinder 212 that is configured to rotate about a fourth axis 214 in the direction of arc D, which is in opposition to the direction of arc C, such as in a clockwise direction.

During operation, each of the rotary cutter 102, the vacuum transfer tool 104, the ultrasonic anvil 106, and the ultrasonic horn 108 may repeatedly or continually rotate (that is, in continuous motion). Further, the valve string 114 and the web 122 are may be in continuous or repeated motion. The valve string 114 and the web 122 can be linearly fed, and can move in parallel together, and in unison. The valve string 114 may be within a first plane 220, and the web 122 may be in a second plane 222. In at least one embodiment, the first plane 220 is parallel with the second plane 222. Optionally, the first plane 220 and the second plane 222 may not be parallel. Also, optionally, the valve string 114 and the web 122 can be fed in opposite directions.

The valve string 114 may pass between a cutting blade of the rotary cutter 102, and the vacuum transfer tool 104, which can provide a vacuum drum that provides a cutting anvil in relation to the rotary cutter 102. This vacuum transfer tool 104 can transfer the cut valves 116 from the valve string 114, and may deposit the valves 116 on the ultrasonic anvil 106. This anvil 106 may provide a second vacuum drum, such as may be contained in an ultrasonic sealing anvil pattern. The ultrasonic anvil 106 may rotate the individual valves 116 into position and can mate the ultrasonic horn 106 (for example, a rotary (lobed) ultrasonic horn) to seal the valves 116 into position on the web 122, which is moving continuously or repeatedly, such as at rates up to 300 pouches per minute.

FIG. 4 illustrates a flow chart of a valve application method, according to an embodiment of the present disclosure. Referring to FIGS. 1-4, at 300, the valve string 114 may be formed having plural individual valves 116 connected together in a side-by-side configuration. In at least one other embodiment, the valves 116 can be connected in an end-to-end configuration. At 302, the valve string 114 may be fed between the rotary cutter 102 and the vacuum transfer tool 104. At 304, the valves 116 can be cut (that is, separated) from the valve string 114 between the rotary cutter 102 and the vacuum transfer tool 104. At 306, the valves 116 may be transferred from the vacuum transfer tool 104 to the ultrasonic anvil 106. At 308, the valves 116 can be ultrasonically sealed to the web 122 that is fed between the ultrasonic anvil 106 and the ultrasonic horn 108.

In one example, a valve application system is provided. This system may include a rotary cutter that may cut individual valves from a valve string, and a vacuum transfer tool. The valve string may be fed between the rotary cutter and the vacuum transfer tool where the rotary cutter can be cut the individual valves from the valve string. The system also may include an ultrasonic anvil. The valves may be transferred from the vacuum transfer tool to the ultrasonic anvil. The system also may include an ultrasonic horn. A web can be fed between the ultrasonic anvil and the ultrasonic horn, where the valves can be ultrasonically sealed to the web.

The valves in the valve strings may be arranged in a side-by-side configuration. The rotary cutter, the vacuum transfer tool, the ultrasonic anvil, and the ultrasonic horn can be at a common location, instead of being at different locations (such as different areas that require removal and transportation of materials between the different locations). The rotary cutter, the vacuum transfer tool, the ultrasonic anvil, and the ultrasonic horn may form a common assembly. The rotary cutter may include a first drum, the vacuum transfer tool may include a second drum, the ultrasonic anvil may include a third drum, and the ultrasonic horn may include a fourth drum, with each drum rotatable around or about a different axis. These axes may be parallel to each other. The first drum, the second drum, the third drum, and the fourth drum may each rotate. The first drum may rotate in a first direction, the second drum may rotate in a second direction in opposition to the first direction, the third drum may rotate in a third direction in opposition to the second direction, and the fourth drum may rotate in a fourth direction in opposition to the third direction.

The first direction and the third direction may be the counterclockwise direction, and the second direction and the fourth direction may be the clockwise direction. The rotary cutter, the vacuum transfer tool, the ultrasonic anvil, and the ultrasonic horn may continually or repeatedly rotate during operation.

In another example, a valve application method is provided. The method may include feeding a valve string between a rotary cutter and a vacuum transfer tool, cutting (by the rotary cutter), individual valves from the valve string, transferring the valves from the vacuum transfer tool to an ultrasonic anvil, feeding a web between the ultrasonic anvil and an ultrasonic horn, and ultrasonically sealing the valves to the web between the ultrasonic horn and the ultrasonic anvil.

The valves in the valve strings may be arranged in a side-by-side configuration. The rotary cutter, the vacuum transfer tool, the ultrasonic anvil, and the ultrasonic horn may be at a common location. The rotary cutter, the vacuum transfer tool, the ultrasonic anvil, and the ultrasonic horn may form a common assembly.

The rotary cutter may include a first drum, the vacuum transfer tool may include a second drum, the ultrasonic anvil may include a third drum, and the ultrasonic horn may include a fourth drum.

The method may also include rotating the first drum, the second drum, the third drum, and the fourth drum. The first drum may be rotated in a first direction, the second drum may be rotated in a second direction in opposition to the first direction, the third drum may be rotated in a third direction in opposition to the second direction, and the fourth drum may be rotated in a fourth direction in opposition to the third direction.

the first direction and the third direction may be counterclockwise, while the second direction and the fourth direction can be clockwise. The method also may include repeatedly or continually rotating the rotary cutter, the vacuum transfer tool, the ultrasonic anvil, and the ultrasonic horn during operation.

In another example, valve application system is provided. This system may include a rotary cutter that can cut individual valves from a valve string. The valves in the valve strings may be arranged in a side-by-side configuration. The rotary cutter may include a first drum configured to rotate in a first direction. The system also may include a vacuum transfer tool. The valve string may be fed between the rotary cutter and the vacuum transfer tool, where the rotary cutter can cut the individual valves from the valve string. The vacuum transfer tool may include a second drum configured to rotate in a second direction in opposition to the first direction. The system also may include an ultrasonic anvil. The valves can be transferred from the vacuum transfer tool to the ultrasonic anvil. The ultrasonic anvil may include a third drum configured to rotate in a third direction in opposition to the second direction. The system also may include an ultrasonic horn. A web can be fed between the ultrasonic anvil and the ultrasonic horn where the valves can be ultrasonically sealed to the web, wherein the ultrasonic horn comprises a fourth drum configured to rotate in a fourth direction in opposition to the third direction. The rotary cutter, the vacuum transfer tool, the ultrasonic anvil, and the ultrasonic horn may continually or repeatedly rotate during operation.

The rotary cutter, the vacuum transfer tool, the ultrasonic anvil, and the ultrasonic horn may be at a common location.

As described herein, embodiments of the present disclosure provide systems and methods for efficiently and effectively applying (such as securing or otherwise coupling) valves to a web of material to form packages, such as pouches.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A valve application system, comprising:
a rotary cutter configured to cut individual valves from a valve string;
a vacuum transfer tool, wherein the valve string is configured to be fed between the rotary cutter and the vacuum transfer tool where the rotary cutter is configured to cut the individual valves from the valve string;
an ultrasonic anvil, wherein the valves are configured to be transferred from the vacuum transfer tool to the ultrasonic anvil; and
an ultrasonic horn, wherein a web is configured to be fed between the ultrasonic anvil and the ultrasonic horn where the valves are ultrasonically sealed to the web.

2. The valve application system of claim 1, wherein the valves in the valve strings are arranged in a side-by-side configuration.

3. The valve application system of claim 1, wherein the rotary cutter, the vacuum transfer tool, the ultrasonic anvil, and the ultrasonic horn are at a common location.

4. The valve application system of claim 1, wherein the rotary cutter, the vacuum transfer tool, the ultrasonic anvil, and the ultrasonic horn form a common assembly.

5. The valve application system of claim 1, wherein the rotary cutter comprises a first drum, the vacuum transfer tool comprises a second drum, the ultrasonic anvil comprises a third drum, and the ultrasonic horn comprises a fourth drum.

6. The valve application system of claim 5, wherein the first drum, the second drum, the third drum, and the fourth drum are configured to rotate.

7. The valve application system of claim 6, wherein the first drum rotates in a first direction, the second drum rotates in a second direction in opposition to the first direction, the third drum rotates in a third direction in opposition to the second direction, and the fourth drum rotates in a fourth direction in opposition to the third direction.

8. The valve application system of claim 7, wherein the first direction and the third direction are counterclockwise, and wherein the second direction and the fourth direction are clockwise.

9. The valve application system of claim 1, wherein the rotary cutter, the vacuum transfer tool, the ultrasonic anvil, and the ultrasonic horn are configured to continually rotate during operation.

10. A valve application method, comprising:
feeding a valve string between a rotary cutter and a vacuum transfer tool;
cutting, by the rotary cutter, individual valves from the valve string;
transferring the valves from the vacuum transfer tool to an ultrasonic anvil;
feeding a web between the ultrasonic anvil and an ultrasonic horn; and
ultrasonically sealing the valves to the web between the ultrasonic horn and the ultrasonic anvil.

11. The valve application method of claim 10, wherein the valves in the valve strings are arranged in a side-by-side configuration.

12. The valve application method of claim 10, wherein the rotary cutter, the vacuum transfer tool, the ultrasonic anvil, and the ultrasonic horn are at a common location.

13. The valve application method of claim 10, wherein the rotary cutter, the vacuum transfer tool, the ultrasonic anvil, and the ultrasonic horn form a common assembly.

14. The valve application method of claim 10, wherein the rotary cutter comprises a first drum, the vacuum transfer tool comprises a second drum, the ultrasonic anvil comprises a third drum, and the ultrasonic horn comprises a fourth drum.

15. The valve application method of claim 14, further comprising rotating the first drum, the second drum, the third drum, and the fourth drum.

16. The valve application method of claim 15, wherein the first drum rotates in a first direction, the second drum rotates in a second direction in opposition to the first direction, the third drum rotates in a third direction in opposition to the second direction, and the fourth drum rotates in a fourth direction in opposition to the third direction.

17. The valve application method of claim 16, wherein the first direction and the third direction are counterclockwise, and wherein the second direction and the fourth direction are clockwise.

18. The valve application method of claim 10, further comprising continually rotating the rotary cutter, the vacuum transfer tool, the ultrasonic anvil, and the ultrasonic horn during operation.

19. A valve application system, comprising:
a rotary cutter configured to cut individual valves from a valve string, wherein the valves in the valve strings are arranged in a side-by-side configuration, and wherein the rotary cutter comprises a first drum configured to rotate in a first direction;
a vacuum transfer tool, wherein the valve string is configured to be fed between the rotary cutter and the vacuum transfer tool where the rotary cutter is configured to cut the individual valves from the valve string, wherein the vacuum transfer tool comprises a second drum configured to rotate in a second direction in opposition to the first direction;
an ultrasonic anvil, wherein the valves are configured to be transferred from the vacuum transfer tool to the ultrasonic anvil, wherein the ultrasonic anvil comprises a third drum configured to rotate in a third direction in opposition to the second direction; and
an ultrasonic horn, wherein a web is configured to be fed between the ultrasonic anvil and the ultrasonic horn where the valves are ultrasonically sealed to the web, wherein the ultrasonic horn comprises a fourth drum configured to rotate in a fourth direction in opposition to the third direction,
wherein the rotary cutter, the vacuum transfer tool, the ultrasonic anvil, and the ultrasonic horn are configured to continually rotate during operation.

20. The valve application system of claim 19, wherein the rotary cutter, the vacuum transfer tool, the ultrasonic anvil, and the ultrasonic horn are at a common location.
